(19) United States
(12) Patent Application Publication
(10) Pub. No.: US 2004/0154042 A1
(43) Pub. Date: Aug. 5, 2004

(54) Digital broadcast system device and method

(76) Inventor: Tony Caporicci, Las Vegas, NV (US)

Correspondence Address: Barbara M. Burns, # 276, 1756 Plymouth Road, Ann Arbor, MI, 48105, US

(21) Appl. No.: 10/729,085

(22) Filed: Dec. 5, 2003

Related U.S. Application Data
(60) Provisional application No. 60/432,090, filed on Dec. 10, 2002.

(51) Int. Cl. H04N 7/16; H04N 7/173

(52) U.S. Cl. 725/87; 725/5

(57) ABSTRACT

A device for viewing entertainment in a private individual setting comprises payment module to deliver a block of time of content from a local or wide area servers and played on a pay per view basis on a display monitor. On payment the server allows access to content. Content is stored on a local server or connected directly to a main server which renews the title list of available entertainment. Connection with an external server allows more content to be made available.

### REFERENCE TO RELATED APPLICATION

This application is based on provisional patent application serial No. 60/432,090, filed Dec. 10, 2002.

### BACKGROUND OF THE INVENTION

The field of the invention pertains to entertainment and, in particular, to a digital broadcast system device for the delivery of personal entertainment and method for operating the device.

A major problem with entertainment is that the entertainment is often delivered to a large number of people such as in a concert format. Some people may wish to see something else. This makes it difficult to deliver entertainment in a public place and to provide the variety of entertainment that different people desire. A concert type format for entertainment delivery may not desirable for a location such as an airport or other public space.

A device and a way to deliver entertainment were needed to allow the viewer to select the desired entertainment in a private location. With a view toward providing a more useful device and way to view individual entertainment selections, applicant has developed the following device and method of use of the device.

### SUMMARY OF THE INVENTION

Device

The device for viewing entertainment in an individualized setting comprises cash/coin/credit card operated equipment to deliver a block of time or play (content) from a local or wide area servers and played on a pay per view basis. Each block of time or play requires payment in which a time limit is based on charges to the user/viewer. The system may have a viewing booth. Once the user inserts payment, the server allows access to the content. The content is stored on a local server or connected directly to a main server which renews the title list of available entertainment. The title list is available to the user as a group (in categories) or as one title at a time.

The device/machine comprises components for user interaction. The components are a payment module, a printer, a computer and a case, which presents advertising displays. Advertising displays can be back-lit.

The payment module is comprised of a bill acceptor and coin mechanism for the insertion of money, a credit card reader for payment by credit card, loyalty card, a coupon, a scanner to recognize coupons, bar codes, tickets, loyalty cards. A touchscreen and optional button are provided for navigation through the menus. A printer is provided for receipt, ticket or coupon printing. A computer is provided to control, connect and navigate the viewing.

The device/machine connects to a display to present the content that is selected on the machine. The display monitor can be a television, a Cathode Ray Tube (CRT), Liquid Crystal Display (LCD) or Plasma Display or to the Computer Display LCD/Plasma or CRD displays to present the content that is selected on the machine device. The television or computer display monitor's content is controlled by the device.

The device connects to a server on-site or a server off-site which makes the content available from a storage system and data base methods and routines. The server controls the payment requirement at the machine and monitors usage as well as uptime. Each transaction is recorded and each of the sessions builds usage activity history presenting information about time spent on the device, content selected by the user(s), the amount of money inserted, etc.

The system can also employ a motion sensor connected to the device to detect presence by the device. The motion sensor can be connected to an external indicator such as a light can be used to display whether the booth itself or the area nearby is occupied or vacant. Additionally, an alarm can be operated when the booth is occupied but no payment or activity at the machine has occurred.

The server storage system allows for the same or different content to be distributed to each machine and for each machine to display the content as long as the server instructs the machine to play selected content based on payment terms presented on the interface or the instructions.

The machine can play selected titles at the same time of at different times (at each machine) while another machine is doing the same accessing the same of different content files.

The machines and server are connected via a local area network, wide area network, Internet, Intranet, extranet, wireless or via satellite, or by other connecting means. Each of the files of content is stored on a central server system, which categorizes and makes available the list to the machines. The central server system can also connect to the local server which acts a secondary storage solution to make content locally accessible so that an always on connection is not necessary.

Operation of the Device

An interface screen is presented to the user to allow the user to select titles from a listing of content titles. By transacting the payment method, the user then can view the selected title. The user can also browse previews prior to the selection or access other areas as permitted by the administrator or server without requirement for payment.

Once the title is selected payment transaction is required by inserting either cash (money in the form of bill or coin, credit card (merchant processing cards such as VISA, M/C, AMEX or stored value cards such as company or bank operated credit cards, debit cards, membership cards) or other methods of payment (coupons, tickets, bar codes, chips, cell phones, e-wallets, etc.). The selected title is then viewed for the time allocated by the administrator or server. The user can be presented the content on a separate display device such as a computer monitor (LCD, CRT or Plasma) or television.

The owner or the establishment receives content via the Internet, wide area network, wireless network or Intranet. The content can be stored on a local server or distributed direct to the user as the user selects. The owner or establishment also receives accounting and usage reports to understand the income and activity of the machines reported to a web site so that the information can be retrieved from any computer connected to the Internet. The user has a list of titles that can be accessed (up to hundreds even thousands of titles can be enlisted or if the owner or establishment offers only just one content title then only one title will be listed.

The system also contains a security protocol which includes a tamper alarm, motion sensors and lighting alarm which notifies the owner or establishment of vandalism, tampering, booth or area occupancy, and reports this information to a server which posts the information to a web site and/or local monitoring station which records and displays the information.

The system can be installed in public access areas such as arcades, movie theatres, airplanes, bus terminals, trains, hotel rooms, nightclubs, bars, apartments, convention centers, sports parks, restaurants, and other high traffic locations.

The benefit realized by the device and the method for operating the device is the providing of private individualized entertainment to a viewer for a time period controlled by the viewer by payment.

### BRIEF DESCRIPTION OF THE DRAWINGS

FIG. 1 illustrates a perspective view of part of the interior of the device;

FIG. 2 illustrates a perspective view from above of the device;

FIG. 3 illustrates a front view of the control panel module;

FIG. 4 illustrates a side view of the control panel module;

FIG. 5A illustrates the display aspect components of the device;

FIG. 5B illustrates the video server and reporting server and the connection to the display aspect components of the device;

FIG. 5C illustrates club server or external publishers or other content providers connected via the Internet to the video server and reporting server;

FIG. 6A illustrates the invention in a first variation;

FIG. 6B illustrates the invention in a second variation; and

FIG. 6C illustrates the invention in a third variation.

### DESCRIPTION OF THE PREFERRED EMBODIMENT

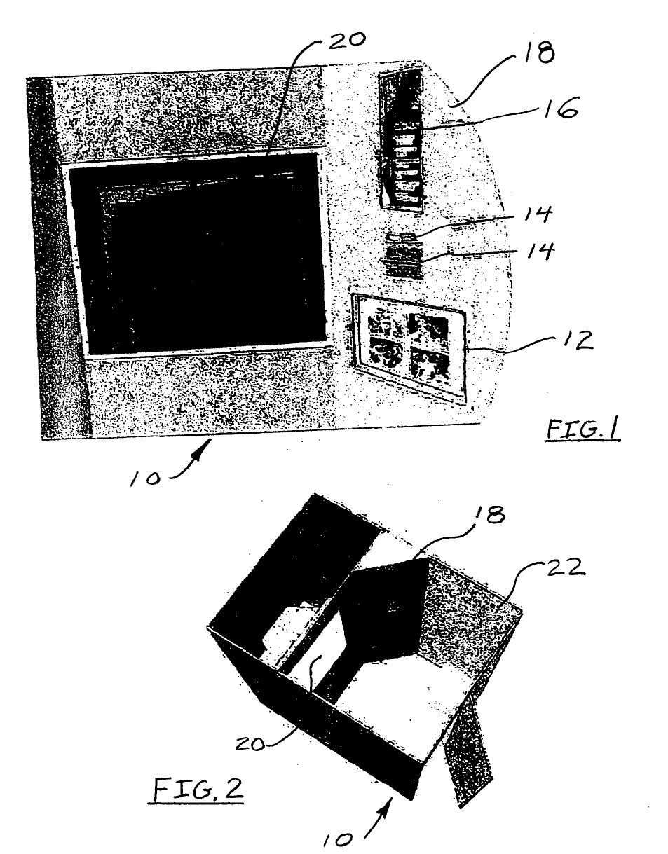

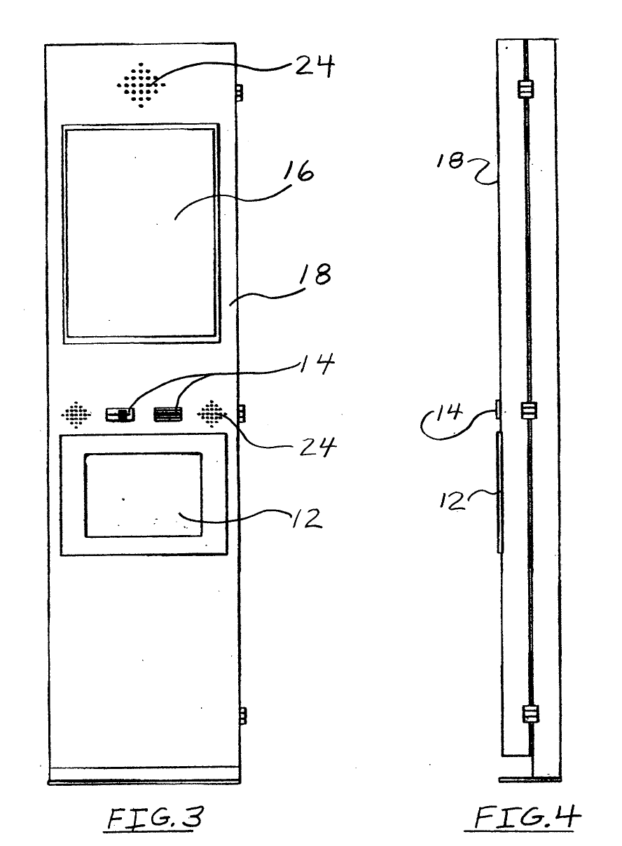

Illustrated in FIG. 1 is the new digital broadcast system device and method 10 of the invention. Interior of device 10 comprises a control monitor 12, payment module/s 14, and back-lit advertising display 16. Control monitor 12, payment module/s 14, and back-lit advertising display 16 can be provided in a control panel module 18. Display monitor 20 is provided for viewing of a selected content file or feed. Cubicle 22 forms walls of device 10 and is better seen in FIG. 2.

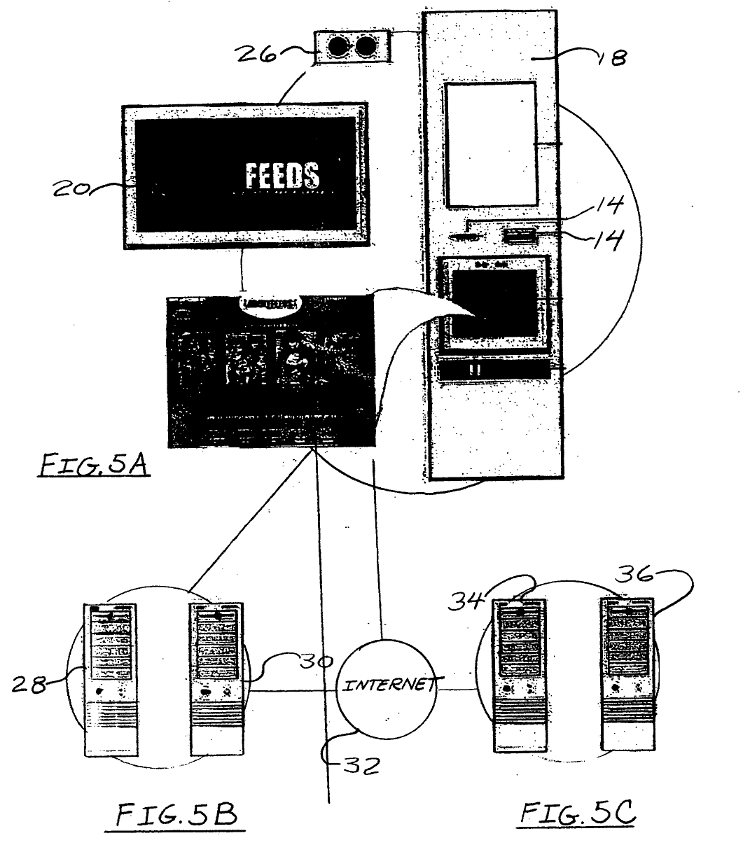

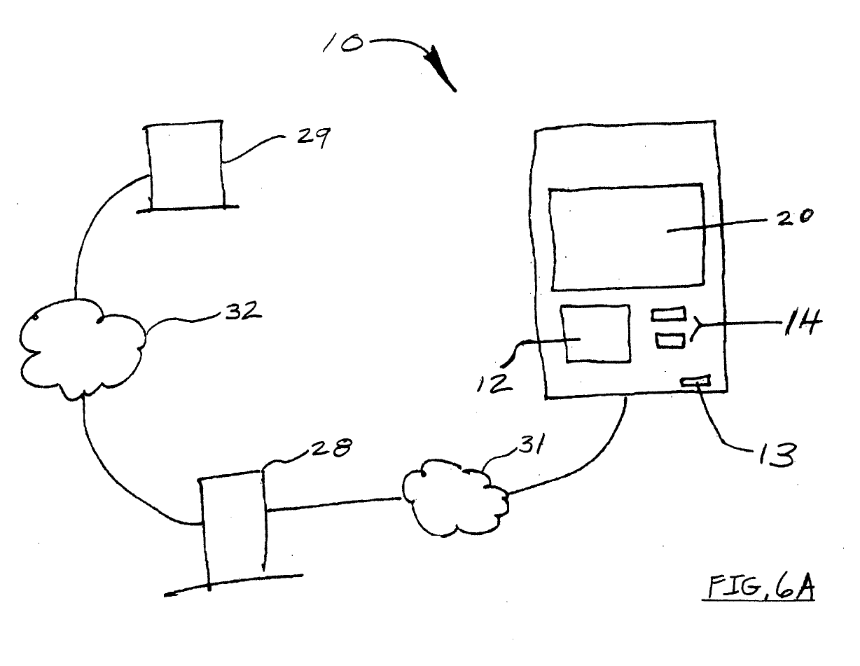

Now turning to FIG. 3 and 4, control panel module 18 is thereshown. Control panel module 18 has control monitor 12, payment module/s 14, back-lit advertising display 16 and audio delivery devices 24.

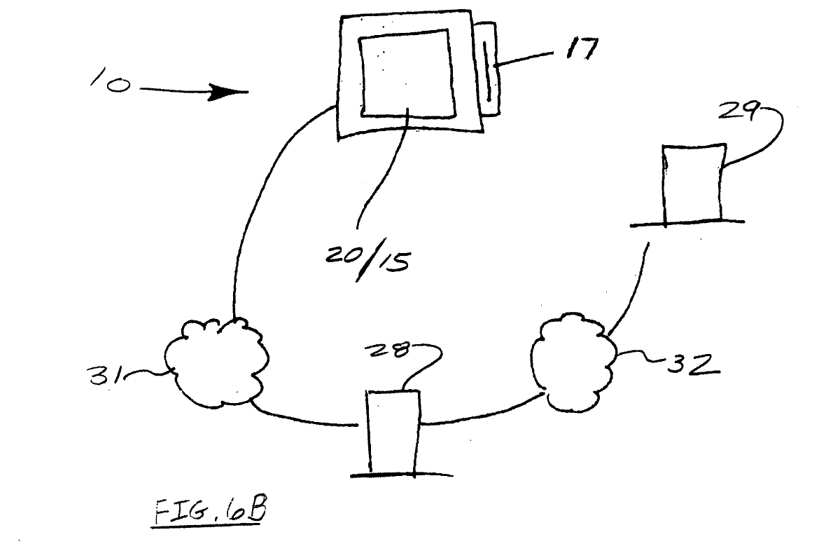

Device 10 is depicted in FIG. 5A as having control panel module 18, display monitor 20 to provide display aspect of device 10. Occupancy indicator 26 can be used to indicate device is in use.

FIG. 5B depicts video server 28 and reporting server 30 connected with the display aspect depicted in FIG. 5A.

Connected through the Internet 32 or through another connection avenue, FIG. 5C depicts club server 34 or external publishers or other content providers 36.

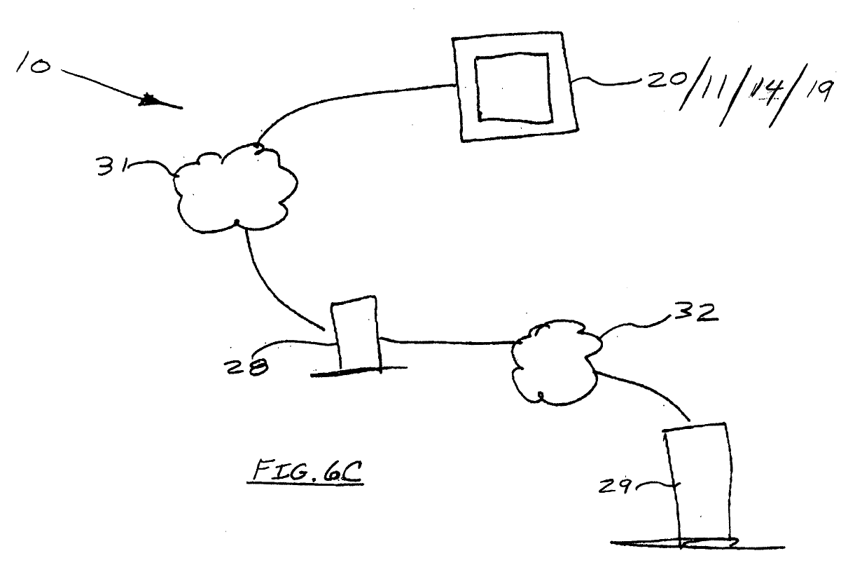

Now turning to FIG. 6A, device 10 is depicted as having display monitor 20 to provide display aspect of device 10. Display monitor 20 is encased in display monitor case 21. Control display 12 is a touchscreen display and payment modules 14 are also part of display monitor case 21.

Programmable computer 13 is also part of control display case 21.

Network 31 connects display monitor 20 and the elements connected with display monitor case 21 to a video server 28 and through internet network 32 to another video server 29.

Device 10 is depicted in FIG. 6B as having display monitor 20 with Central Processing Unit 15 and card reader 17 affixed thereto. Display monitor 20 is connected through network 31 to video server 28 and through internet network 32 to another video server 29.

In FIG. 6C device 10 is depicted as display monitor 20 with software 11, payment module 14 and gateway 19 therein. Display monitor 20 is connected through network 31 to video server 28 and through internet network 32 to another video server 29.

1. A device for viewing entertainment in a private individual setting comprises:
a control monitor to control access to a server,
a display monitor to display selected content available for selection through the control monitor,
a payment module for payment to determine length of display of selected content from one of a local server and an external server on the display monitor, and at least one of a local server and access to an external server for expanded content selection.

2. A device for viewing entertainment in a private individual setting according to claim 1 wherein the server can access content stored on one of a local server and an external server.

3. A device for viewing entertainment in a private individual setting according to claim 2 further comprising
a limited access booth surrounding the display monitor.

4. A device for viewing entertainment in a private individual setting according to claim 3 wherein a user of the device controls access to the limited access booth surrounding the display monitor.

5. A device for viewing entertainment in a private individual setting according to claim 1 further comprising
a printer for printing a receipt of payment received by payment module.

6. A device for viewing entertainment in a private individual setting according to claim 1 further comprising
an advertising module.

7. A device for viewing entertainment in a private individual setting according to claim 6 wherein the advertising module has back lighting.

8. A device for viewing entertainment in a private individual setting according to claim 3 further comprising a sensor for indicating the limited access booth as being occupied.

9. A device for viewing entertainment in a private individual setting according to claim 8 further comprising a sensor for indicating the limited access booth as being occupied and the payment module has not been operated.

10. A device for viewing entertainment in a private individual setting according to claim 1 wherein multiple private individual settings can be controlled by one control monitor.

11. A device for viewing entertainment in a private individual setting according to claim 1 wherein multiple private individual settings can access the selected content simultaneously.

12. A device for viewing entertainment in an individual setting comprises:
a control monitor to control access to a server,
a display monitor to display selected content available for selection through the control monitor,
a module to determine length of display of selected content from one of a local server and an external server on the display monitor, and at least one of a local server and access to an external server for expanded content selection.

13. A method of use for device according to claim 1 for viewing entertainment in a private individual setting comprises the following steps:
using a control monitor to control access to a server, paying by operating a payment module for payment to determine length of display,
viewing a display monitor to display selected content from one of a local server and an external server.

14. A method of use for device according to claim 13 for viewing entertainment in a private individual setting further comprising the following step:
limiting access to a limited access area for the display of selected content.
